(19) United States
(12) Patent Application Publication
(10) Pub. No.: US 2023/0385311 A1
(43) Pub. Date: Nov. 30, 2023

(54) Semantic-Temporal Visualization of Information

(71) Applicant: BASF SE, Ludwigshafen am Rhein (DE)

(72) Inventors: Henning Schwabe, Ludwigshafen (DE); Arunav Mishra, Mannheim (DE); Juergen Mueller, Ludwigshafen (DE)

(21) Appl. No.: 18/030,597

(22) PCT Filed: Oct. 7, 2021
(86) PCT No.: PCT/EP2021/077794

§ 371 Date: Apr. 6, 2023

(30) Foreign Application Priority Data
Oct. 7, 2020 (EP) 20200484.2

(51) Int. Cl. G06F 16/31; G06F 16/34; G06F 40/30; G06F 16/335

(52) U.S. Cl. CPC G06F 16/313; G06F 16/34; G06F 40/30; G06F 16/335

(57) ABSTRACT

A computer-implemented method for generating digital information data in a subject area is proposed. The method comprises:
providing, at a processing unit, digital information corpus data;
extracting, via the processing unit, digital information seed data from the digital information corpus data;
performing, via the processing unit, a search in at least one database comprising knowledge information, thereby extracting a plurality of text blocks related to the subject area from the at least one database; wherein the search is performed based upon the digital information seed data,
indexing, via the processing unit, the text blocks in temporal sequence;
generating, via the processing unit, the digital information data using the temporally organized text blocks.

### TECHNICAL FIELD

The invention relates to a computer-implemented method for generating digital information data in a subject area. Moreover, the invention relates to a computer system for generating digital information data in a subject area. The method and the computer system may be used for an innovation chain from research and development to product launch such as on the technical field of chemistry. Other applications are possible.

### BACKGROUND ART

Digitalization initiatives in many technical fields constantly identify the user need to automatically establish causal dependencies in a set of documents accessed via search engine or network drive, in order to guide user attention rapidly to the most important facts across multiple documents. Ranking of search results is simply not designed for this task. Documents processed by semantic information extraction and represented as semantic network in a knowledge base could fulfill this task. Yet, knowledge bases are slow and expensive to build. More advanced approaches to “logical understanding” of software agents are still in various stages of AI research so there is an opportunity for pragmatic approximation of causal dependencies in an inexpensive technical implementation.

US 2016/0188642 A1 discloses a computer-implemented method for combining a primary document with one or more candidate documents. The method comprises extracting process steps disclosed in the primary document and extracting candidate process steps disclosed in the one or more candidate documents; constructing a primary data structure corresponding to the primary document, wherein the primary data structure comprises interconnected nodes and each node corresponds to an extracted process step disclosed in the primary document; identifying one or more candidate processes to combine with the primary data structure; and inserting the one or more identified candidate process steps into the primary data structure.

US 2016/0162486A1 discloses a computer-enabled method of assisting to generate an innovation. The method comprises the steps of retrieving from a data base a first set of more than two documents belonging to a first domain; retrieving from said database a second set of more than two documents belonging to a second domain: selecting all possible combinations of documents from the first set with all documents in said second set, and for each combination of documents: determining a composite novelty score, a composite proximity score and a composite impact score; and based on all of the determined composite novelty scores and/or composite proximity scores and/or composite impact scores, providing a recommendation which can assist to generate an innovation.

U.S. Pat. No. 9,799,040 B2 discloses a method of computer assisted innovation. The method provides a method which can automatically generate suggested innovation opportunities which may then be viewed or otherwise communicated to and analysed by a user. The disclosure provides a method and apparatus for determining innovation opportunities by selecting one or more terms; determining trend data relating to a selected element; determining an innovation likelihood measure for said selected element in dependence upon said trend data; identifying an innovation opportunity in dependence upon said innovation likelihood measure.

Despite the achievements so far, there is still a need for enhanced information visualization and knowledge management, specifically along an innovation chain from research and development to product launch.

### Problem to be Solved

It is therefore desirable to provide methods and devices which address the above-mentioned technical challenges. Specifically, devices and methods for generating digital information data in a subject area via at least one processing unit shall be provided which allow for enhanced information visualization and knowledge management.

### SUMMARY

This problem is addressed by a computer-implemented method for generating digital information data in a subject area and a computer system with the features of the independent claims. Advantageous embodiments which might be realized in an isolated fashion or in any arbitrary combinations are listed in the dependent claims.

In a first aspect of the present invention, a computer-implemented method for generating digital information data in a subject area is proposed.

The term “computer-implemented” as used herein is a broad term and is to be given its ordinary and customary meaning to a person of ordinary skill in the art and is not to be limited to a special or customized meaning. The term specifically may refer, without limitation, to a process which is fully or partially implemented by using a data processing means, such as data processing means comprising at least one processing unit. The term “computer”, thus, may generally refer to a device or to a combination or network of devices having at least one data processing means such as at least one processing unit. The computer, additionally, may comprise one or more further components, such as at least one of a data storage device, an electronic interface or a human-machine interface.

The term “processing unit” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processing unit may be configured for processing basic instructions that drive the computer or system. As an example, the processing unit may comprise at least one arithmetic logic unit (ALU), at least one floating-point unit (FPU), such as a math coprocessor or a numeric coprocessor, a plurality of registers, specifically registers configured for supplying operands to the ALU and storing results of operations, and a memory, such as an L1 and L2 cache memory. In particular, the processing unit may be a multicore processor. Specifically, the processing unit may be or may comprise a central processing unit (CPU). Additionally or alternatively, the processing unit may be or may comprise a microprocessor, thus specifically the processing unit's elements may be contained in one single integrated circuitry (IC) chip. Additionally or alternatively, the processing unit may be or may comprise one or more application specific integrated circuits (ASICs) and/or one or more field-programmable gate arrays (FPGAs) or the like.

The term “database” as used herein is a broad term and is to be given its ordinary and customary meaning to a person of ordinary skill in the art and is not to be limited to a special or customized meaning. The term specifically may refer, without limitation, to an arbitrary collection of information and/or to a physical structure configured for storing an arbitrary collection of information. The database may be comprise at least one storage device configured for storing information. The database may be or may comprise at least one element selected from the group consisting of: at least one server, at least one server system comprising a plurality of server, at least one cloud server or cloud computing infrastructure. The method may be performed using a plurality of databases such as at least one document store and at least one knowledge base, as will be outlined in detail below. The method may be performed using one database configured for fulfilling a plurality of functionalities such as data storage and knowledge storage. For example, the document store may be integral to the knowledge base or may be an external device.

The term “storage” as used herein is a broad term and is to be given its ordinary and customary meaning to a person of ordinary skill in the art and is not to be limited to a special or customized meaning. The term specifically may refer, without limitation, to a process of recording and/or retraining of data.

The term “subject area” as used herein is a broad term and is to be given its ordinary and customary meaning to a person of ordinary skill in the art and is not to be limited to a special or customized meaning. The term specifically may refer, without limitation, to a branch of knowledge such as medicine, chemistry, physics or the like.

The term “digital information data” as used herein is a broad term and is to be given its ordinary and customary meaning to a person of ordinary skill in the art and is not to be limited to a special or customized meaning. The term specifically may refer, without limitation, to a discrete, discontinuous representation of arbitrary textual information. The digital information data may comprise one or more of a scientific document, a research related document, a development related document, a business-related document, a company related document, a legal document, a patent document, a regulatory document, an operating manual, an instruction manual, a training material and the like.

The computer-implemented method comprises the following steps, which may be performed in the given order. However, a different order may also be possible. Further, one or more than one or even all of the steps may be performed once or repeatedly. Further, the method steps may be performed in a timely overlapping fashion or even in parallel. The method may further comprise additional method steps which are not listed.

The method comprises the following steps:
providing, at a processing unit, digital information corpus data;
extracting, via the processing unit, digital information seed data from the digital information corpus data;
performing, via the processing unit, a search in at least one database comprising knowledge information, thereby extracting a plurality of text blocks related to the subject area from the at least one database; wherein the search is performed based upon the digital information seed data,
indexing, via the processing unit, the text blocks in temporal sequence;
generating, via the processing unit, the digital information data using the temporally organized text blocks.

The term “providing” digital information corpus data as used herein is a broad term and is to be given its ordinary and customary meaning to a person of ordinary skill in the art and is not to be limited to a special or customized meaning. The term specifically may refer, without limitation, to entering, storing and/or uploading the digital information corpus data.

The digital information corpus data may be arbitrary digital information data. For example, the digital information corpus data may comprise complete digital information data such as a complete document, e.g. comments or notices, or the digital information corpus data may comprise at least one part of the digital information data such as at least one sentence.

The term “seed data” is a broad term and is to be given its ordinary and customary meaning to a person of ordinary skill in the art and is not to be limited to a special or customized meaning. The term specifically may refer, without limitation, to data that have been populated a database with at the time it is created. Seeding of data is used to provide initial values for lookup lists, for demo purposes, proof of concepts and the like.

The term “extracting” seed data as used herein is a broad term and is to be given its ordinary and customary meaning to a person of ordinary skill in the art and is not to be limited to a special or customized meaning. The term specifically may refer, without limitation, to digitally excerpt data form a given data corpus.

As outlined above, the method comprises performing, via the processing unit, at least a search in at least one database comprising knowledge information, thereby extracting a plurality of text blocks related to the subject area from the at least one database; wherein the search is performed based upon the digital information seed data. Specifically, the search may be a semantic search that is performed in the database. The term “semantic search” as used herein is a broad term and is to be given its ordinary and customary meaning to a person of ordinary skill in the art and is not to be limited to a special or customized meaning. The term specifically may refer, without limitation, to search considering at least one meaning of a search term. The semantic search may be performed using at least one machine-learning tool such as a neural-network. The semantic search may comprise performing a document search query based on the seed data.

The term “syntactic search” as used herein is a broad term and is to be given its ordinary and customary meaning to a person of ordinary skill in the art and is not to be limited to a special or customized meaning. The term specifically may refer, without limitation, to search for literal matches with a search term in the database. The term “semantic search” as used herein is a broad term and is to be given its ordinary and customary meaning to a person of ordinary skill in the art and is not to be limited to a special or customized meaning. The term specifically may refer, without limitation, to search considering at least one meaning of a search term. The syntactic and/or semantic search may be performed using at least one machine-learning tool such as a neural-network.

The semantic search may comprise performing a document search query based on the portion of digital information data. The processing unit may be configured for identifying automatically or by selection by the user, information within the portion of digital information data for which the document search is performed. The processing unit may be configured for identifying and resolving ambiguity and/or errors of the information provided by the user for which the document search is performed. For example, the processing unit may be configured for suggesting synonyms, terms, expressions, vocabulary, numbers, formulae, sentences or addresses, which may be displayed by the user interface for selection and/or approval by the used. The portion of digital information data may be compared syntactically and/or semantically to digital information data stored in the database. The document search may comprise determining a syntactic and/or semantic overlap between the portion of digital information data and the entries of the document store. A syntactic and/or semantic search index may be provided by the processing unit. The syntactic and/or semantic search index may comprise a list of all search results. Via the presentation of search results the user may be allowed to look at what is already present in the database. Moreover, via the presentation of search results the user may be allowed to look at at least one context in which the search terms derived from the portion of digital information data he has entered is stored so far in the database.

The term “document” as used herein is a broad term and is to be given its ordinary and customary meaning to a person of ordinary skill in the art and is not to be limited to a special or customized meaning. The term specifically may refer, without limitation, to an arbitrary digital representation of thought. The term “document” moreover may refer to an object class comprising written text and/or at least one drawing. The document may be a scientific document, a research related document, a development related document, a business-related document, a company related document, a legal document, a patent document, a regulatory document, an operating manual, an instruction manual, a training material and the like. The document may be or may comprise at least one report, at least one comment, at least one note, at least one scientific paper, at least one plot, at least one operating manual, at least one instruction, at least one web site and the like. A document may also be a customer feedback related to a product of a production process.

As outlined above, the method comprises indexing, via the processing unit, the text blocks in temporal sequence. The term “indexing the text blocks in temporal sequence” as used herein is a broad term and is to be given its ordinary and customary meaning to a person of ordinary skill in the art and is not to be limited to a special or customized meaning. The term specifically may refer, without limitation, to a temporal connections mapping of the text blocks. The term “text block” as used herein is a broad term and is to be given its ordinary and customary meaning to a person of ordinary skill in the art and is not to be limited to a special or customized meaning. The term specifically may refer, without limitation, to a passage of text such as a passage of a text document.

As outlined above, the method comprises generating, via the processing unit, the digital information data using the temporally organized text blocks. The term “generating the digital information data using the temporally organized text blocks” as used herein is a broad term and is to be given its ordinary and customary meaning to a person of ordinary skill in the art and is not to be limited to a special or customized meaning. The term specifically may refer, without limitation, to creation of digital information data based on the temporally organized text blocks. Applicant has found that temporal indexing of data elements is proportional to causality. Thus, mapping elements in temporal space can indicate causality of a topic in the subject area. The method works best if text blocks are selected from a reasonably bounded knowledge sources, or by being bound to a specific domain.

This may allow detection of causalities that would otherwise be very hard to capture. E.g. in recent times the collection of customer feedback is more and more common practice. The customer feedback may be an indication of undetected problems in the production process. Some but not all customer feedback may be an indication of undetected problems in the production process. Furthermore, customer feedback often suffers from not having standardized formats and expressions. It is very difficult to assess whether a customer complaint indeed points to an error in production or represents a single customer being unsatisfied. The use of temporal organized text blocks according to the invention may allow to identify when an error in the production process likely occurred. This may then trigger an investigation of the root cause. Consequently, the temporal indexing is not just another parameter to track but may comprises additional information related to a production process. The inventive method therefore may allow to detect hidden patterns and causalities.

The processing unit may be operatively coupled to the at least one database. The term “operatively coupled” as used herein is a broad term and is to be given its ordinary and customary meaning to a person of ordinary skill in the art and is not to be limited to a special or customized meaning. The term specifically may refer, without limitation, to a communication connection between the processing unit and the at least one database for one or more of transferring information, accessing to storage or controlling at least one function of the other device. The processing unit and the database may comprise at least one communication interface via which the processing unit and the database are operatively coupled. The processing unit may be configured for accessing, such as reading and writing, to storage stored in the database via the communication interface. The term “communication interface” as used herein is a broad term and is to be given its ordinary and customary meaning to a person of ordinary skill in the art and is not to be limited to a special or customized meaning. The term specifically may refer, without limitation, to an item or element forming a boundary configured for transferring information. In particular, the communication interface may be configured for transferring information from a computational device, e.g. a computer, such as to send or output information, e.g. onto another device. Additionally or alternatively, the communication interface may be configured for transferring information onto a computational device, e.g. onto a computer, such as to receive information. The communication interface may specifically provide means for transferring or exchanging information. In particular, the communication interface may provide a data transfer connection, e.g. Bluetooth, NFC, inductive coupling or the like. As an example, the communication interface may be or may comprise at least one port comprising one or more of a network or internet port, a USB-port and a disk drive. The communication interface may be at least one web interface.

Extracting the digital information seed data may include semantic information extraction. With other words, the information may be extracted based on semantic interrelations of the seed data.

The method may further comprise filtering the extracted digital information seed data by process attributes by the processing unit. The term “process attribute” as used herein is a broad term and is to be given its ordinary and customary meaning to a person of ordinary skill in the art and is not to be limited to a special or customized meaning. The term specifically may refer, without limitation, to a type of process data variable that specifically relates to the operations of a process, such as a task ID or a participant. Many process attributes are provided out of the box, but they can also be created on your own. By filtering using a process attribute, e.g. IPC class or Project ID, irrelevant subject matter can be filtered out.

Extracting the plurality of text blocks may include selecting sections to decompose the knowledge information from the database into text blocks. Thus, the text blocks may be created by separating a text into a certain number of text blocks.

The method may further comprise recursively calculating semantic similarity between the extracted text blocks by the processing unit. Thus, the text blocks may be provided in an order of relevance relative to the search query.

The method may further comprise selecting for each of the indexed text blocks having a predetermined time stamp a predetermined number of previous text blocks, and identifying for each concept in the text block having the predetermined time stamp a list of candidate concepts in the database by clustering of embeddings against concept embeddings in all of the previous text blocks.

The term “embedding” as used herein is a broad term and is to be given its ordinary and customary meaning to a person of ordinary skill in the art and is not to be limited to a special or customized meaning. The term specifically may refer, without limitation, to the collective name for a set of language modeling and feature learning techniques in natural language processing (NLP) where words or phrases from the vocabulary are mapped to vectors of real numbers. Conceptually it involves a mathematical embedding from a space with many dimensions per word to a continuous vector space with a much lower dimension. Methods to generate this mapping include neural networks, dimensionality reduction on the word co-occurrence matrix, probabilistic models, explainable knowledge base method, and explicit representation in terms of the context in which words appear. Word and phrase embeddings, when used as the underlying input representation, have been shown to boost the performance in NLP tasks such as syntactic parsing and sentiment analysis.

The database may comprise at least one knowledge base comprising a plurality of concepts. The term “knowledge base” as used herein is a broad term and is to be given its ordinary and customary meaning to a person of ordinary skill in the art and is not to be limited to a special or customized meaning. The term specifically may refer, without limitation, to an ontology comprising at least one hierarchy of classes, sub-classes and instances. The classes are denoted concepts herein. The concepts may be physical and/or chemical concepts, scientific concepts, technical terms and the like. The knowledge base may comprise a unique identifier for each entry of the document store. In addition to the unique ID, the knowledge base may comprise a plurality of meta-data strings. The term “meta-data string” as used herein is a broad term and is to be given its ordinary and customary meaning to a person of ordinary skill in the art and is not to be limited to a special or customized meaning. The term specifically may refer, without limitation, to data that provides information about other data. Specifically, a meta-data string may function as pointer to at least one other object which may have in turn at least one additional pointer. Each of the concepts of the knowledge base may be represented by a meta-data string. Each of the concepts may be linked to at least one entry of the document store. The meta-data string may comprise information about connected entries such as documents or insights of the document store and connection to other concepts such as higher level concepts and/or subconcepts. As the knowledge base comprises for each entry of the document store a unique identifier, the processing unit can determine and provide the corresponding meta-data string for entries of the syntactic and/or semantic search index. The meta-data strings provided in response to the at least one syntactic and/or semantic search may comprise information about at least one concept.

The method may further comprise applying a learning-to-rank model trained on existing digital information corpus data at the processing unit using features that evaluate graph relations among candidate concepts and evaluate semantic similarities between the text block having the predetermined time stamp and all of the previous text blocks.

The term “learning-to-rank model” as used herein is a broad term and is to be given its ordinary and customary meaning to a person of ordinary skill in the art and is not to be limited to a special or customized meaning. The term specifically may refer, without limitation, to the application of machine learning, typically supervised, semi-supervised or reinforcement learning, in the construction of ranking models for information retrieval systems. Training data consists of lists of items with some partial order specified between items in each list. This order is typically induced by giving a numerical or ordinal score or a binary judgment (e.g. “relevant” or “not relevant”) for each item. The ranking model purposes to rank, i.e. producing a permutation of items in new, unseen lists in a similar way to rankings in the training data. Learning-to-rank is also known as machine-learned ranking (MLR).

The method may further comprise annotating the text block having the predetermined time stamp with top-k-ranked candidate concepts. Thus, the text block having the predetermined time stamp is evaluated based on the candidate concepts so as to define a certain order of relevance.

The method may further comprise connecting the text block having the predetermined time stamp with top-k-ranked text blocks of the previous text blocks and marking it with a score of the learning-to-rank model. Thus, the order of relevance of the text block having the predetermined time stamp is defined with the most relevant concept at top.

The method may further comprise repeating the step of selecting the previous text blocks, identifying the list of candidate concepts, applying the learning-to-rank model and annotating the text block having the predetermined time stamp until all text blocks are clustered. Thus, the ranking and ordering according to relevance is carried out until all text blocks are processed so as to reveal the best quality of potential relevance.

The method may further comprise transferring, particularly writing, the text blocks to a semantic graph as nodes labeled with a predetermined time bin at the processing unit. Thus, the semantic interrelations are visualized in a predetermined order established with the method steps explained before.

The method may further comprise forming, particularly writing, connections between the text blocks to the semantic graph as traces, particularly as directed edges, at the processing unit. Thus, the semantic interrelations of the text blocks are visualized.

Generating the digital information data may include generating a visualization indicating a temporal distance and a semantic distance of the text blocks. Thus, temporal information as well as semantic information across the text blocks can be derived at a single glance.

The visualization is an interactive 2D tree visualization with text blocks nodes as symbols and traces, particularly edges, as arrows, sorted by time index. By visually tracing text blocks from documents through time and semantic space semantic-temporal trees allow to approximate the flow of causal reasoning through the document set. Special attention can be paid to conspicuous clustering and early cut-off of branches that may indicate over and under-researched topics, respectively. In addition, unexpected combinations of terms inspire new directions of analysis.

A distance in x-direction indicates temporal distance of time index steps and a distance in y direction indicates a score of the learning-to-rank model relative to text blocks in previous time index. Thus, a clear arrangement of the temporal information as well as semantic information across the text blocks can be derived at a single glance.

The visualization allows easy recognition of the time evolution of semantics. This is in particular useful, when dealing with complex matters such as user complaints, that may indicate an error in a production process. The 2-D visualization is makes it very easy to spot the first occurrence of a chain of semantical similarities. In particular, when used to link customer feedback to errors in production, it is very important to not only track semantic similarities, customers may use different terminology, but also visualizing the temporal sequence. A single occurrence of a customer feedback to a specific topic may not be relevant, however it this is followed by various text blocks with similar semantics, than this may be a trigger that an error in the production process occurred prior to the first customer feedback.

In a further aspect a computer program generating digital information data in a subject area is proposed. The computer program comprises instructions which, when the program is executed by a computer or a computer network, cause the computer or the computer network to fully or partially perform the method for generating digital information data in a subject area according to the present invention in one or more of the embodiments enclosed herein. For possible definitions of most of the terms used herein, reference may be made to the description of the computer implemented method generating digital information data in a subject area above or as described in further detail below.

Specifically, the computer programs may be stored on a computer-readable data carrier and/or on a computer-readable storage medium. As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM). For example, the computer program may be stored using at least one database such as of a server or a cloud server.

Further disclosed and proposed herein is a computer program product having program code means, in order to perform the methods according to the present invention in one or more of the embodiments enclosed herein when the program is executed on a computer or computer network. Specifically, the program code means may be stored on a computer-readable data carrier and/or computer-readable storage medium. As used herein, a computer program product refers to the program as a tradable product. The product may generally exist in an arbitrary format, such as in a paper format, or on a computer-readable data carrier. Specifically, the computer program product may be distributed over a data network.

Further disclosed and proposed herein is a data carrier having a data structure stored thereon, which, after loading into a computer or computer network, such as into a working memory or main memory of the computer or computer network, may execute the methods according to the present invention in one or more of the embodiments disclosed herein.

In a further aspect, a computer system for generating digital information data in a subject area is disclosed. The computer system comprises at least one database and at least one processing unit. The processing unit is configured for providing digital information corpus data. The processing unit is configured for extracting digital information seed data from the digital information corpus data. The processing unit is configured for performing a search in the at least one database comprising knowledge information, thereby extracting a plurality of text blocks related to the subject area from the at least one database; wherein the search is performed based upon the digital information seed data. The processing unit is configured for indexing the text blocks in temporal sequence. The processing unit is configured for generating the digital information data using the temporally organized text blocks.

The at least one processing unit may be operatively coupled to the at least one database.

The proposed method and device allow enhanced exploitation of the inherent consistency and reduced noise-level of document content generated by said work processes for a rapid, approximate 2D visualization based on existing information extraction techniques. By visually tracing text blocks from documents through time and semantic space semantic-temporal trees allow to approximate the flow of causal reasoning through the document set. Special attention can be paid to conspicuous clustering and early cut-off of branches that may indicate over and under-researched topics, respectively. In addition, unexpected combinations of terms inspire new directions of analysis.

The proposed method and computer system allow enhanced information retrieval and knowledge management through insight capturing. Especially along the innovation chain from research and development to product launch and customer service the impact of insight capturing may allow reducing time-to-market and may allow faster problem solving to respond to customer requests. Insight built on top of existing insights may allow to trigger a new level of organization wide learning that can enhance effectiveness and impact of new ideas created by users.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, non-withstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:
Embodiment 1. A computer-implemented method for generating digital information data in a subject area, the method comprising:
   providing, at a processing unit, digital information corpus data;
   extracting, via the processing unit, digital information seed data from the digital information corpus data;
   performing, via the processing unit, a search in at least one database comprising knowledge information, thereby extracting a plurality of text blocks related to the subject area from the at least one database; wherein the search is performed based upon the digital information seed data,
   indexing, via the processing unit, the text blocks in temporal sequence;
   generating, via the processing unit, the digital information data using the temporally organized text blocks.
Embodiment 2. The method according to the preceding embodiment, wherein extracting the digital information seed data includes semantic information extraction.
Embodiment 3. The method according to any preceding embodiment, further comprising filtering the extracted digital information seed data by process attributes by the processing unit.
Embodiment 4. The method according to any preceding embodiment, wherein extracting the plurality of text blocks includes selecting sections to decompose the knowledge information from the database into text blocks.
Embodiment 5. The method according to any preceding embodiment, further comprising recursively calculating semantic similarity between the extracted text blocks by the processing unit.
Embodiment 6. The method according to any preceding embodiment, further comprising selecting for each of the indexed text blocks having a predetermined time stamp a predetermined number of previous text blocks, and identifying for each concept in the text block having the predetermined time stamp a list of candidate concepts in the database by clustering of embeddings against concept embeddings in all of the previous text blocks.
Embodiment 7. The method according to the preceding embodiment, further comprising applying a learning-to-rank model trained on existing digital information corpus data at the processing unit using features that evaluate graph relations among candidate concepts and evaluate semantic similarities between the text block having the predetermined time stamp and all of the previous text blocks.
Embodiment 8. The method according to the preceding embodiment, further comprising annotating the text block having the predetermined time stamp with top-k-ranked candidate concepts.
Embodiment 9. The method according to the preceding embodiment, further comprising connecting the text block having the predetermined time stamp with top-k-ranked text blocks of the previous text blocks and marking it with a score of the learning-to-rank model.
Embodiment 10. The method according to the preceding embodiment, further comprising repeating the step of selecting the previous text blocks, identifying the list of candidate concepts, applying the learning-to-rank model and annotating the text block having the predetermined time stamp until all text blocks are clustered.
Embodiment 11. The method according to any preceding embodiment, further comprising transferring, particularly writing, the text blocks to a semantic graph as nodes labeled with a predetermined time bin at the processing unit.
Embodiment 12. The method according to the preceding embodiment, further comprising forming, particularly writing, connections between the text blocks to the semantic graph as traces, particularly as directed edges, at the processing unit.
Embodiment 13. The method according to any one of embodiments 6 to 12, wherein generating the digital information data includes generating a visualization indicating a temporal distance and a semantic distance of the text blocks.
Embodiment 14. The method according to the preceding embodiment, wherein the visualization is an interactive 2D tree visualization with text blocks nodes as symbols and traces, particularly edges, as arrows, sorted by time index.
Embodiment 15. The method according to the preceding embodiment, wherein a distance in x-direction indicates temporal distance of time index steps and a distance in y direction indicates a score of the learning-to-rank model relative to text blocks in previous time index.
Embodiment 16. A computer program including computer-executable instructions for performing the method according to any preceding embodiment.
Embodiment 17. A computer-readable storage medium having stored thereon computer-executable instructions for implementing a method according to any one of embodiments 1 to 15.
Embodiment 18. A computer system for generating digital information data in a subject area, comprising:
   comprising at least one database and at least one processing unit, wherein the processing unit is configured for providing digital information corpus data, wherein the processing unit is configured for extracting digital information seed data from the digital information corpus data, wherein the processing unit is configured for performing a search in the at least one database comprising knowledge information, thereby extracting a plurality of text blocks related to the subject area from the at least one database; wherein the search is performed based upon the digital information seed data, wherein the processing unit is configured for indexing the text blocks in temporal sequence, and wherein the processing unit is configured for generating the digital information data using the temporally organized text blocks.
Embodiment 19. The computer system according to the preceding embodiment, wherein the at least one processing unit is operatively coupled to the at least one database
Embodiment 20. The computer system according to any one of the preceding embodiments referring to a computer system, wherein computer system is configured for performing the for generating digital information data in a subject area via the at least one processing unit according to any one of the preceding embodiments referring to a method for generating digital information data in a subject area.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows a flow chart of a computer-implemented method for generating digital information data in a subject area according to the present invention;

FIG. 2 shows a visualization indicating temporal distance and semantic distance given a set of user-selected concepts;

FIG. 3 shows a visualization indicating temporal distance and semantic distance applied to a production process; and

FIG. 4 shows a system according to the invention.

### DETAILED DESCRIPTION OF THE EMBODIMENTS

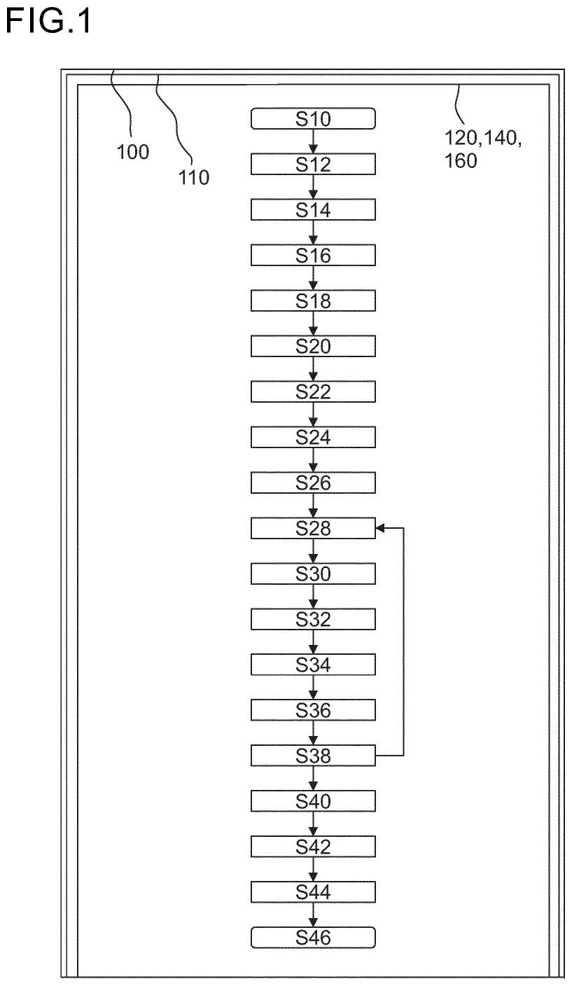

FIG. 1 shows a flow chart of a computer-implemented method for generating digital information data in a subject area according to the present invention. The method may be performed by a computer system 100 via at least one processing unit 110 according to the present invention. The processing unit 110 may be operatively coupled to at least one database 120.

The processing unit 110 may be or may comprise an arbitrary logic circuitry configured for performing basic operations of a computer or system, and/or, generally, to a device which is configured for performing calculations or logic operations. In particular, the processing unit 110 may be configured for processing basic instructions that drive the computer or system. As an example, the processing unit 110 may comprise at least one arithmetic logic unit (ALU), at least one floating-point unit (FPU), such as a math coprocessor or a numeric coprocessor, a plurality of registers, specifically registers configured for supplying operands to the ALU and storing results of operations, and a memory, such as an L1 and L2 cache memory. In particular, the processing unit 110 may be a multicore processor. Specifically, the processing unit 110 may be or may comprise a central processing unit (CPU). Additionally or alternatively, the processing unit 110 may be or may comprise a microprocessor, thus specifically the processing unit's elements may be contained in one single integrated circuitry (IC) chip. Additionally or alternatively, the processing unit 110 may be or may comprise one or more application specific integrated circuits (ASICs) and/or one or more field-programmable gate arrays (FPGAs) or the like.

The database 120 may be or may comprise an arbitrary collection of information and/or to a physical structure configured for storing an arbitrary collection of information. The database 120 may be comprise at least one storage device configured for storing information. The database 120 may be or may comprise at least one element selected from the group consisting of: at least one server, at least one server system comprising a plurality of server, at least one cloud server or cloud computing infrastructure. The method may be performed using a plurality of databases 120. The database 120 may include further sub-units such as at least one document store 140 and may additionally or alternatively include at least one knowledge base 160. The method may be performed using one database 120 configured for fulfilling a plurality of functionalities such as data storage and knowledge storage. For example, the document store 140 may be integral to the knowledge base 160 or may be an external device.

The digital information data may be a discrete, discontinuous representation of arbitrary textual information. The digital information data may comprise one or more of a scientific document, a research related document, a development related document, a business-related document, a company related document, a legal document, a patent document, a regulatory document, an operating manual, an instruction manual, a training material and the like.

The processing unit 110 is operatively coupled to the at least one database 120. Specifically, a communication connection is present between the processing unit 110 and the at least one database 120 for one or more of transferring information, accessing to storage or controlling at least one function of the other device. The processing unit 110 and the database 120 may comprise at least one communication interface via which the processing unit 110 and the database 120 are operatively coupled. The processing unit 110 may be configured for accessing, such as reading and writing, to storage stored in the database via the communication interface. The communication interface may be or may comprise an item or element forming a boundary configured for transferring information. In particular, the communication interface may be configured for transferring information from a computational device, e.g. a computer, such as to send or output information, e.g. onto another device. Additionally or alternatively, the communication interface may be configured for transferring information onto a computational device, e.g. onto a computer, such as to receive information. The communication interface may specifically provide means for transferring or exchanging information. In particular, the communication interface may provide a data transfer connection, e.g. Bluetooth, NFC, inductive coupling or the like. As an example, the communication interface may be or may comprise at least one port comprising one or more of a network or internet port, a USB-port and a disk drive. The communication interface may be at least one web interface.

As shown by the flowchart of FIG. 1, the method starts with step S10 where the processing unit 110 is provided. In a subsequent step S12, digital information corpus data are provided at the processing unit 110. Particularly, in step S12 word and document embeddings for concepts are computed once for the entire digital information corpus data. Thereby, digital information seed data are extracted from the digital information corpus data. In a subsequent step S14, a search in the at least one database 120 comprising knowledge information is performed, thereby extracting a plurality of text blocks related to the subject area from the at least one database. The search is performed based upon the digital information seed data. For example, a user queries a semantic search engine on the digital corpus data annotated by semantic information extraction. In a subsequent step S16, the extracted digital information seed data are filtered by process attributes by the processing unit 110. For example, a user filters the extracted digital information seed data by process attributes such as IPC class or Project ID. The user may be a human user. In a subsequent step S18, section headings are extracted from the thus found documents. As shown in a subsequent step S20, extracting the plurality of text blocks includes selecting sections to decompose the knowledge information from the database into text blocks. For example, a user selects sections to decompose the documents into text blocks. Typical example for sections in patents are “Claims”, “Background”, “Description”, for scientific papers “Introduction”, “Methods”, “Conclusion”. In a subsequent step S22, word and document embeddings for concepts in the text blocks are computed via the processing unit using top-k result documents from the semantic search.

In a subsequent step S24, the text blocks are indexed via the processing unit 110 in temporal sequence. In a subsequent step S26, it is started from the most recent time stamp. In a subsequent step S28, for each of the indexed text blocks having a predetermined time stamp a predetermined number of previous text blocks is selected. For example, for each text block i,j with time stamp j, text blocks m,j−1 are selected. In a subsequent step S30, for each concept in the text block having the predetermined time stamp a list of candidate concepts are identified in the database 120 by clustering of embeddings against concept embeddings in all of the previous text blocks. For example, for each concept in text block i,j, a list of candidate concepts is identified in the database such as the knowledge base by clustering of embeddings against concept embeddings in all text blocks m,j−1. In a subsequent step S32, a learning-to-rank model trained on existing digital information corpus data is applied at the processing unit 110 using features that evaluate graph relations among candidate concepts and evaluate semantic similarities between the text block having the predetermined time stamp and all of the previous text blocks. For example, the learning-to-rank model trained on existing digital corpus data is applied using features that evaluate graph relations among candidate concepts and evaluate semantic similarities between text block i,j and all text blocks m,j−1. In a subsequent step S34, the text block having the predetermined time stamp is annotated with top-k-ranked candidate concepts. For example, text block i,j is annotated with top-k-ranked candidate concepts. In a subsequent step S36, the text block having the predetermined time stamp is connected with top-k-ranked text blocks of the previous text blocks and marked with a score of the learning-to-rank model. For example, text block i,j is connected with top-k-ranked text blocks m,j−1 and an edge is labeled with a score of learning-to-rank model. In a subsequent step S38, the steps of selecting the previous text blocks, identifying the list of candidate concepts, applying the learning-to-rank model and annotating the text block having the predetermined time stamp are repeated until all text blocks are clustered. With other words, steps Step S28 to step S36 are repeated until all text blocks are clustered.

In a subsequent step S40, the text blocks are transferred, such as written, to a semantic graph as nodes labeled with a predetermined time bin at the processing unit 110. For example, text blocks are written to a semantic graph as nodes labeled with time bin i. In a subsequent step S42, connections between the text blocks are formed, such as written, to the semantic graph as traces, such as as directed edges, at the processing unit 110. For example, connections between the text blocks are written to the semantic graph as directed edges. As shown by a subsequent step S44, generating the digital information data includes generating a visualization indicating a temporal distance and a semantic distance of the text blocks. The visualization is an interactive 2D tree visualization with text blocks nodes as symbols and traces, particularly edges, as arrows, sorted by time index. A distance in x-direction indicates temporal distance of time index steps and a distance in y direction indicates a score of the learning-to-rank model relative to text blocks in previous time index. Particularly, an interactive 2D tree visualization with text blocks nodes as symbols and edges as arrows, sorted by time index from left to right is generate where given list of concepts selected by the user from at least one selected text block, text blocks annotated with at least one selected concept are displayed, distance in x direction indicates temporal distance of time index steps and distance in y direction indicates the score of the learning-to-rank model relative to the text blocks in previous time index. In subsequent step S46, the method ends.

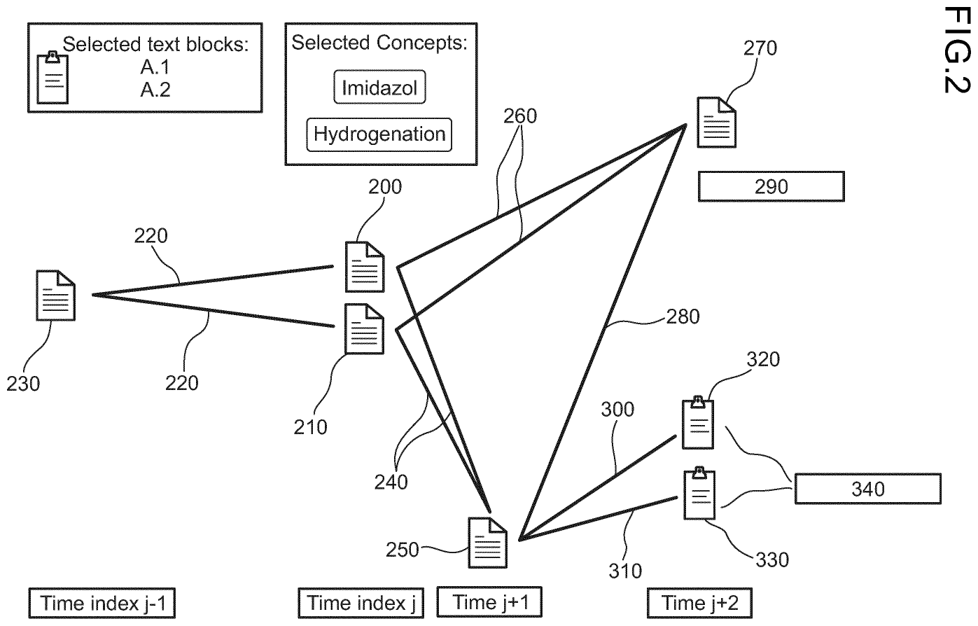

FIG. 2 shows a visualization indicating temporal distance and semantic distance given a set of user-selected concepts. Particularly, FIG. 2 shows the result of the above described method. A distance in x direction indicates temporal distance of time index steps and distance in y direction indicates the score of the learning-to-rank model relative to the text blocks in previous time index. With the example shown in FIG. 2, the selected concepts are Imidazol and Hydrogenation. Merely as an example, two text blocks 200, 210 having the time index j are shown. Each of the two text blocks 200, 210 having the time index j comprises a connection 220 to a text block 230 having the time index j−1. Further, each of the two text blocks 200, 210 having the time index j comprises a connection 240 to a text block 250 having the time index j+1 which comprises a lower value in the y direction meaning a lower score of the learning-to-rank model relative to the text blocks 200, 210 in the previous time index j. Further, each of the two text blocks 200, 210 having the time index j comprises a connection 260 to a text block 270 having the time index j+2 which comprises a higher value in the y direction meaning a higher score of the learning-to-rank model relative to the text blocks 200, 210, 250 in the previous time index j and j+1. Further, the text block 250 having the time index j+1 comprises a connection 280 to the text block 270 having the time index j+2. As indicated by reference numeral 290, a user can click on edges of the text blocks to view ranking score such as at the text block 270 having the time index j+2. As is further shown and merely as an example, the text block 250 having the time index j+1 comprises connections 300, 310 to a first node 320 and to a second node 330. As indicated by reference numeral 340, a user can click on nodes 320, 330 to access the concept selection and to view the text content, meta data and concepts highlighted in the text.

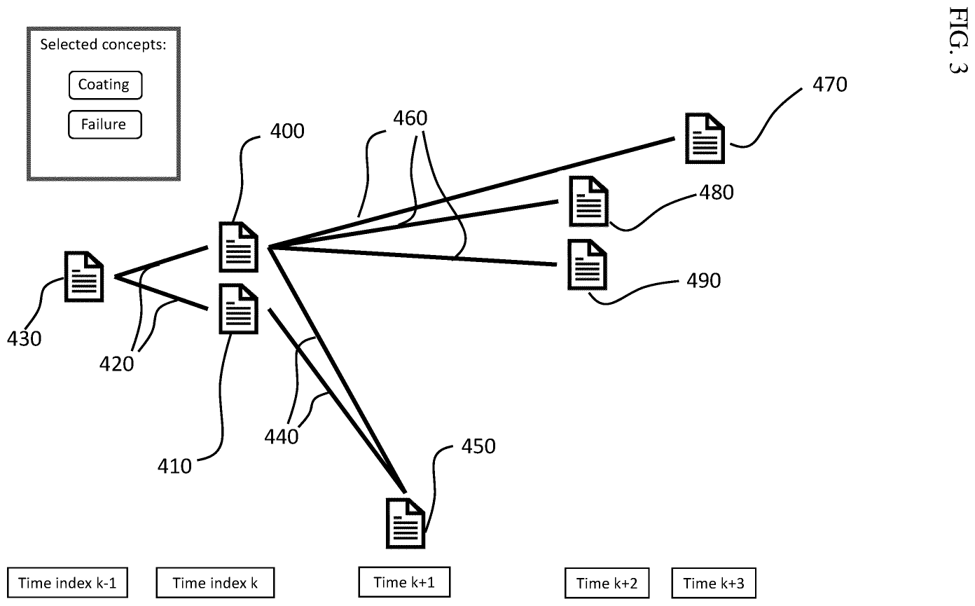

FIG. 3 shows another example of the invention. In this example, the method is applied to a production process in particular in a chemical plant. Maintaining constant quality of products is essential for companies.

In recent times, the collection of customer feedback is more and more common practice. The customer information may be stored in a database. Customer feedback may be an indication of undetected problems in the production process. Some but not all customer feedback may be an indication of undetected problems in the production process. Furthermore, customer feedback often suffers from not having standardized formats and expressions. It is very difficult to assess whether a customer complaint indeed points to an error in production or represents a single customer being unsatisfied.

As a fictitious example, customers from a car manufacturer may complain in various ways:
Color of my car is very angle dependent
Coating does not reflect consistently
Coating looks dull
Engine is very loud
car throttles
etc.

It becomes apparent that the information needs to be clustered according to subjects. At the same time, it is valuable to follow the temporal sequence of the occurrence of the text blocks.

At least a portion of each customer feedback may be considered corpus data.

The visualization indicating temporal distance and semantic distance given a set of a user-selected concepts, in this case the concepts are coating and failure. Particularly, FIG. 3 shows the result of the above described method. A distance in x direction indicates temporal distance of time index steps and distance in y direction indicates the score of the learning-to-rank model relative to the text blocks in previous time index. With the example shown in FIG. 3, the selected concept is coating. Merely as an example, two text blocks 400, 410 having the time index k are shown. Each of the two text blocks 400, 410 having the time index k comprises a connection 420 to a text block 430 having the time index k−1. Further, each of the two text blocks 400, 410 having the time index k comprises a connection 440 to a text block 450 having the time index k+1 which comprises a lower value in the y direction meaning a lower score of the learning-to-rank model relative to the text blocks 400, 410 in the previous time index k. This indicates that the semantics are similar. Further, each of the two text blocks 400, 410 having the time index k comprises a connection 460 to text blocks 480 and 490 having the time index k+2 which comprises a higher value in the y direction meaning a higher score of the learning-to-rank model relative to the text blocks 400, 410, 450 in the previous time index k and k+1. Further text block 470 with temporal index k+3 comprises a connection 460 to text block 400. The cluster 480, 490, 470 is relative consistent in the y direction, indicating that the text blocks are semantically similar. The x-Axis representing the temporal sequence indicates and visualizes that the occurrence of similar text blocks is also closely related in time. This representation allows to directly detect that the text block 400 is likely to be the first occurrence of something that triggered customer feedbacks. This allows to investigate the production process around the time k. For possible errors in the production process. The causal dependency to an error in production may be deduced from the visualization in FIG. 3, which would otherwise not be detected.

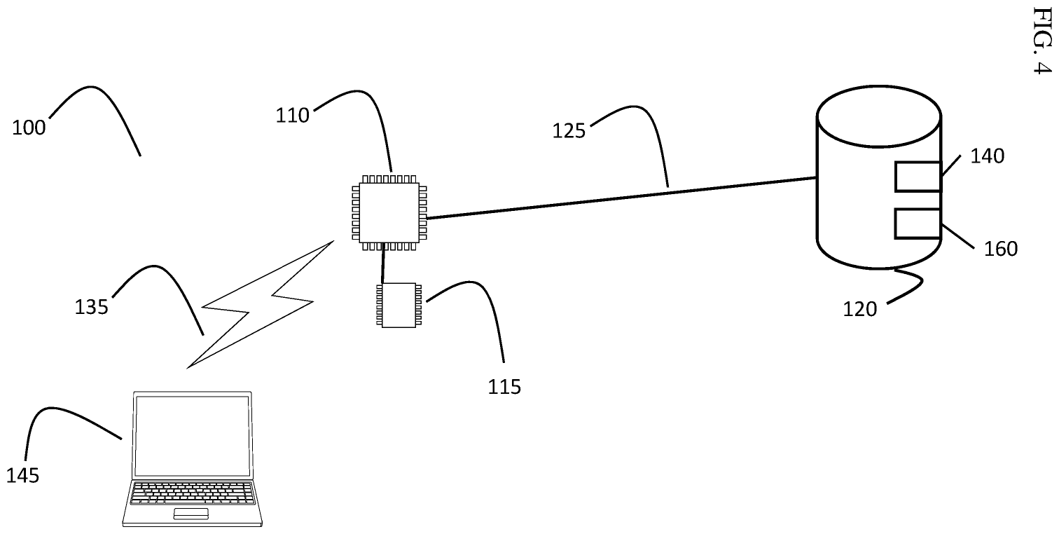

FIG. 4 shows a computer system 100 for generating digital information data in a subject area. The processing unit 110 may be or may comprise an arbitrary logic circuitry configured for performing basic operations of a computer or system, and/or, generally, to a device which is configured for performing calculations or logic operations. In particular, the processing unit 110 may be configured for processing basic instructions that drive the computer or system. As an example, the processing unit 110 may comprise at least one arithmetic logic unit (ALU), at least one floating-point unit (FPU), such as a math coprocessor or a numeric coprocessor, a plurality of registers, specifically registers configured for supplying operands to the ALU and storing results of operations, and a memory, such as an L1 and L2 cache memory. In particular, the processing unit 110 may be a multicore processor. Specifically, the processing unit 110 may be or may comprise a central processing unit (CPU). Additionally or alternatively, the processing unit 110 may be or may comprise a microprocessor, thus specifically the processing unit's elements may be contained in one single integrated circuitry (IC) chip. Additionally or alternatively, the processing unit 110 may be or may comprise one or more application specific integrated circuits (ASICs) and/or one or more field-programmable gate arrays (FPGAs) or the like.

The database 120 may be or may comprise an arbitrary collection of information and/or to a physical structure configured for storing an arbitrary collection of information. The database 120 may be comprise at least one storage device configured for storing information. The database 120 may be or may comprise at least one element selected from the group consisting of: at least one server, at least one server system comprising a plurality of server, at least one cloud server or cloud computing infrastructure. The method may be performed using a plurality of databases 120. The database 120 may include further sub-units such as at least one document store 140 and may additionally or alternatively include at least one knowledge base 160. The method may be performed using one database 120 configured for fulfilling a plurality of functionalities such as data storage and knowledge storage. For example, the document store 140 may be integral to the knowledge base 160 or may be an external device.

The digital information data may be a discrete, discontinuous representation of arbitrary textual information. The digital information data may comprise one or more of a scientific document, a research related document, a development related document, a business-related document, a company related document, a legal document, a patent document, a regulatory document, an operating manual, an instruction manual, a training material and the like.

The processing unit 110 is operatively coupled to the at least one database 120. Specifically, a communication connection 125 is present between the processing unit 110 and the at least one database 120 for one or more of transferring information, accessing to storage or controlling at least one function of the other device. The processing unit may further be coupled to a memory 115, the memory. The processing unit 110 and the database 120 may comprise at least one communication interface via which the processing unit 110 and the database 120 are operatively coupled. The processing unit 110 may be configured for accessing, such as reading and writing, to storage stored in the database via the communication interface. The communication interface may be or may comprise an item or element forming a boundary configured for transferring information. In particular, the communication interface may be configured for transferring information from a computational device, e.g. a computer, such as to send or output information, e.g. onto another device. Additionally or alternatively, the communication interface may be configured for transferring information onto a computational device, e.g. onto a computer, such as to receive information. The communication interface may specifically provide means for transferring or exchanging information. In particular, the communication interface may provide a data transfer connection, e.g. Bluetooth, NFC, inductive coupling or the like. As an example, the communication interface may be or may comprise at least one port comprising one or more of a network or internet port, a USB-port and a disk drive. The communication interface may be at least one web interface. The processing device may further be coupled to a client device 145 in particular via a communication interface 135. In one embodiment, the system may be located in the cloud and the communication interface 135 may be a network connection.

### LIST OF REFERENCE NUMBERS

100 computer system
110 processing unit
120 database
140 document store
160 knowledge base
200 text block
210 text block
220 connection
230 text block
240 connection
250 text block
260 connection
270 text block
280 connection
290 click on edge
300 connection
310 connection
320 first node
330 second node
340 click on node
S10 Start
S12 Compute word & doc embeddings for concepts once for entire in corpus
S14 User queries semantic search engine on corpus annotated by semantic information extraction
S16 User filters by process attribute
S18 Extract section headings from documents
S20 User selects sections to decompose documents into text blocks
S22 Compute word & doc embeddings for concepts in text blocks using top-k result documents from semantic search
S24 Index text blocks in temporal sequence
S26 Start from most recent time stamp
S28 For each text block i,j with time stamp j select text blocks m,j−1
S30 For each concept in text block i,j identify list of candidate concepts in database by clustering of embeddings against concept embeddings in all text blocks m,j−1
S32 Apply learning-to-rank model trained on existing corpus using features that evaluate graph relations among candidate concepts and evaluate semantic similarities between text block i,j and all text blocks m,j−1
S34 Annotate text block i,j with top-k-ranked candidate concepts
S36 Connect text block i,j with top-k-ranked text blocks m,j−1 and label edge with score of learning-to-rank model
S38 Repeat until all text blocks are clustered
S40 Write text blocks to semantic graph as nodes labeled with time bin i
S42 Write connections between text blocks to semantic graph as directed edges
S44 Generate interactive 2D tree visualization with text blocks nodes as symbols and edges as arrows, sorted by time index from left to right where given list of concepts selected by the user from at least one selected text block, text blocks annotated with at least one selected concept are displayed, distance in x indicates temporal distance of time index steps, and distance in y indicates score of learning-to-rank model relative to text blocks in previous time index
S46 End
400 text block
410 text block
420 connection
430 text block
440 connection
450 text block
460 connection
470 text block
480 text block
490 text block

1. A computer-implemented method for generating digital information data in a subject area, the method comprising:
providing, at a processing unit (110), digital information corpus data;
extracting, via the processing unit (110), digital information seed data from the digital information corpus data;
performing, via the processing unit (110), a search in at least one database (120) comprising knowledge information, thereby extracting a plurality of text blocks related to the subject area from the at least one database (120); wherein the search is performed based upon the digital information seed data,
indexing, via the processing unit (110), the text blocks in temporal sequence;
generating, via the processing unit (110), the digital information data using the temporally organized text blocks.

2. The method according to the preceding claim, wherein extracting the digital information seed data includes semantic information extraction.

3. The method according to any preceding claim, further comprising filtering the extracted digital information seed data by process attributes by the processing unit (110).

4. The method according to any preceding claim, wherein extracting the plurality of text blocks includes selecting sections to decompose the knowledge information from the database (120) into text blocks.

5. The method according to any preceding claim, further comprising recursively calculating semantic similarity between the extracted text blocks by the processing unit (110).

6. The method according to any preceding claim, further comprising selecting for each of the indexed text blocks having a predetermined time stamp a predetermined number of previous text blocks, and identifying for each concept in the text block having the predetermined time stamp a list of candidate concepts in the database (120) by clustering of embeddings against concept embeddings in all of the previous text blocks.

7. The method according to the preceding claim, further comprising applying a learning-to-rank model trained on existing digital information corpus data at the processing unit (110) using features that evaluate graph relations among candidate concepts and evaluate semantic similarities between the text block having the predetermined time stamp and all of the previous text blocks.

8. The method according to the preceding claim, further comprising annotating the text block having the predetermined time stamp with top-k-ranked candidate concepts.

9. The method according to the preceding claim, further comprising connecting the text block having the predetermined time stamp with top-k-ranked text blocks of the previous text blocks and marking it with a score of the learning-to-rank model.

10. The method according to the preceding claim, further comprising repeating the steps of selecting the previous text blocks, identifying the list of candidate concepts, applying the learning-to-rank model and annotating the text block having the predetermined time stamp until all text blocks are clustered.

11. The method according to any preceding claim, further comprising transferring, particularly writing, the text blocks to a semantic graph as nodes labeled with a predetermined time bin at the processing unit (110).

12. The method according to the preceding claim, further comprising forming, particularly writing, connections between the text blocks to the semantic graph as traces, particularly as directed edges, at the processing unit (110).

13. The method according to any one of claims 6 to 12, wherein generating the digital information data includes generating a visualization indicating a temporal distance and a semantic distance of the text blocks.

14. The method according to the preceding claim, wherein the visualization is an interactive 2D tree visualization with text blocks nodes as symbols and traces, particularly edges, as arrows, sorted by time index.

15. The method according to the preceding claim, wherein a distance in x-direction indicates temporal distance of time index steps and a distance in y direction indicates a score of the learning-to-rank model relative to text blocks in previous time index.

16. A computer program including computer-executable instructions for performing the method according to any preceding claim.

17. A computer-readable storage medium having stored thereon computer-executable instructions for implementing a method according to any one of claims 1 to 15.

18. A computer system (100) for generating digital information data in a subject area, comprising:
comprising at least one database (120) and at least one processing unit (110), wherein the processing unit (110) is configured for providing digital information corpus data, wherein the processing unit (110) is configured for extracting digital information seed data from the digital information corpus data, wherein the processing unit (110) is configured for performing a search in the at least one database (120) comprising knowledge information, thereby extracting a plurality of text blocks related to the subject area from the at least one database (120); wherein the search is performed based upon the digital information seed data, wherein the processing unit (110) is configured for indexing the text blocks in temporal sequence, and wherein the processing unit (110) is configured for generating the digital information data using the temporally organized text blocks.

19. The computer system according to the preceding claim, wherein the at least one processing unit (110) is operatively coupled to the at least one database (120)

20. The computer system according to any one of the preceding claims referring to a computer system, wherein computer system is configured for performing the for generating digital information data in a subject area via the at least one processing unit (110) according to any one of the preceding claims referring to a method for generating digital information data in a subject area.
